(19) United States
(12) Patent Application Publication
(10) Pub. No.: US 2009/0323019 A1
(43) Pub. Date: Dec. 31, 2009

(54) OPHTALMIC LENS AND METHOD FOR PRODUCING SAME

(75) Inventors: Guy Gerbaud, Eguilles (FR); Philippe Albert, Toulon (FR)

Correspondence Address: YOUNG & THOMPSON, 209 Madison Street, Suite 500, Alexandria, VA, 22314, US

(73) Assignee: ICE FOSTER LIMITED, TORTOLA (GB)

(21) Appl. No.: 12/375,764

(22) PCT Filed: Jul. 31, 2006
(86) PCT No.: PCT/FR2006/050766

§ 371 Date: Jan. 30, 2009

(51) Int. Cl. G02C 7/06; B29D 11/00

(52) U.S. Cl. 351/169; 351/168; 264/1.32

(57) ABSTRACT

The invention concerns a method for producing a lens (6), one side of which (9, 10) has a complex multifocal or progressive or regressive multifocal surface (7). This method comprises the following steps: 1—forming a mold (1) composed of two parts (2, 3), each having an imprint (4, 5); 2—machining at least one of the imprints (4, 5), via a first machining with a digitally controlled, micrometrically precise machine using a computer file of tool movement points defining a complex surface (7), and a nanometric finish machining with a digitally controlled diamond turning tool; 3—injecting a thermoplastic polymer-based material into the mold (1). The invention also concerns a complex lens made of injected thermoplastic polymer, particularly methyl polymethacrylate.

The present invention refers to a lens made of polymer plastic designed particularly for ophthalmic use and the manufacturing process for such a lens and a pair of glasses.

The invention has an application in the field of optics, for the manufacture of glasses fitted with lenses. More particularly, the lenses manufactured in accordance with the invention are suitable for complex corrections involving the use of progressive or degressive lenses, in particular for short- or long-sighted wearers. The invention applies to the manufacture of glasses of all complex forms such as multifocal lenses of varying strengths.

In particular, a complex surface may not have any prismatic value in the geometric and optical centre of the lens, making it similar to a monofocal lens.

Two types of polymers are used in the field of optics i.e. thermoset polymers and thermoplastic polymers. The first of these categories is used solely to manufacture individual items finished by moulding, or semi-finished individual items finished in a surfacing laboratory. Such semi-finished lenses are used to produce customised finished lenses adapted to the correction requirements of individual wearers of glasses. The range of optical corrections possible is, however, very wide and very precise as regards this manufacturing process.

Lenses made of thermoplastics are well-known. They may be finished or semi-finished products as described above. However, they cannot be used for the production, by direct injection, of finished lenses with complex surfaces such as progressive multifocals because, as the technology stands today, the polishing of the mould would lead to a loss of definition in the complex surface and, therefore, in the quality of the optical correction.

Thermoplastic injection is currently used solely for the mass production of simple monofocal or afocal lenses, for example for sunglasses.

In document FR-A-2 689 654, a compromise was proposed between the two types of polymers indicated above. On this subject, the French publication proposed a lens consisting of a “sandwich” of several lenses including one front lens made of thermoset polymer (of the type known commercially as CR 39) that can be precision-moulded using a glass die to form a complex surface for multifocal correction. The sandwich also includes one back lens made of thermoset material (such as polycarbonate or polyurethane) in a non-complex form that can therefore be made by an injection process.

However, the lens proposed by FR-A-2 689 654 is expensive to produce because it requires the overlay and assembly of several different lenses. The overlay of lenses also leads to difficulties with machining, especially as the multilayered lens is an anisotropic assembly.

There is therefore a need for lenses made of a thermoplastic material and suitable for complex corrections of the progressive multifocal type.

However, the current state of technology, illustrated by FR 2 689 654, leads to a negative perception stating that the injection of a thermoplastic polymer such as polycarbonate cannot be used to manufacture complex-surface lenses such as progressive multifocal.

The present invention overcomes all or some of the aforesaid drawbacks and, to this end, proposes a new manufacturing process and a new plastic lens.

More particularly, the invention process allows for the creation of a thermoplastic injection die with imprints in which the surface condition and shape definition are particularly accurate, enabling the manufacture in a single stage (the injection stage) of a finished lens with a surface condition and shape-related properties appropriate for complex optical corrections such as progressive or degressive multifocal correction.

It is evident that such a process will allow for the production of a large quantity of finished lenses, significantly reducing the cost and marketing prices of glasses fitted with such lenses.

It has also been noted, somewhat surprisingly, that thermoplastic polymers such as methyl polymethacrylate produced very good results during the injection phase while at the same time achieving very satisfactory optical properties. The selection of material for the manufacture of lenses with complex optical correction is therefore particularly advantageous, reducing the manufacturing costs of glasses.

Other aims and advantages will become apparent from the following description of a preferred, but not restrictive, use of the invention.

Before proceeding to the description, it should be remembered that the invention refers to a manufacturing process for a lens on which at least one of the sides has a complex surface of the multifocal, progressive multifocal or degressive multifocal type. According to the invention, the process includes the following steps:

1°—building of a die in two sections, each having an imprint;

2°—tooling of at least one of the imprints by:
initial tooling with a micrometric numeric machine and a tool displacement point computer program to mark out a complex surface,
nanometric end tooling using a numeric diamond turning machine;

3°—injection of a thermoset polymer into the die to produce a lens having a complex surface on at least one side.

The advantages of this process include, but are not limited to, the following:
both imprints are tooled during step 2 above,
the second imprint is tooled by a micrometric numeric machine using a tool displacement points computer program to define a spherical and convex surface (8) before polishing,
a diamond-turning tool is used for tooling with micrometric precision,
the injection material is polycarbonate-based,
the injection material is methyl polymethacrylate-based,
the steel die has a Rockwell hardness rating of HRC 55,
the die is shaped to enable the simultaneous production of two lenses having a complex surface on at least one side forming the front of a pair of glasses,
the injection process involves bi-injection with one or two thermoset polymers,
the die is configured to manufacture the temples of a pair of glasses in one piece with the front.

The invention also refers to a lens obtained using the aforesaid process.

The invention also refers to a polymer lens for glasses on which at least one of the sides has a complex surface of the multifocal, progressive multifocal or degressive multifocal type, characterised in that it is made completely of injected methyl polymethacrylate.

The enclosed drawings are included as examples and do not limit the invention. They represent only one embodiment of the invention and make it easily understandable.

FIG. 1 is a cross-section of part of a die used according to the invention to create a complex surface.

FIG. 2 is a view from above.

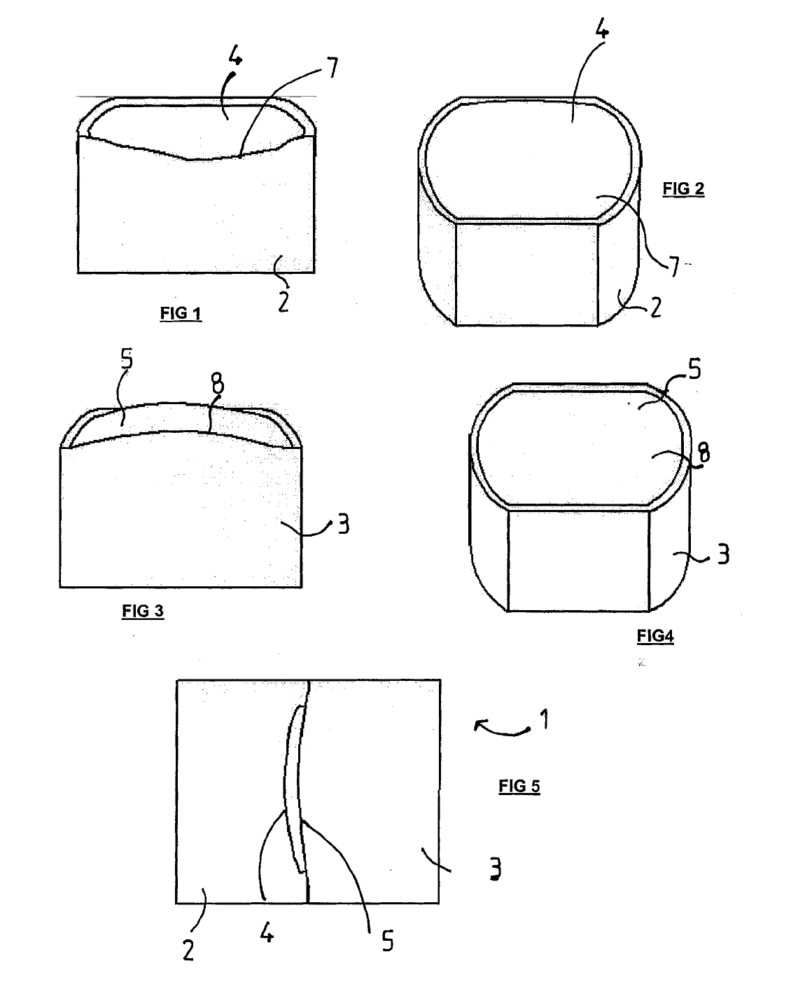

FIG. 3 is a cross-section of another part of the die used to create a convex spherical surface.

FIG. 4 is a view slightly from above.

FIG. 5 shows a section of a two-part die assembly, the die being as illustrated in FIGS. 1 to 4.

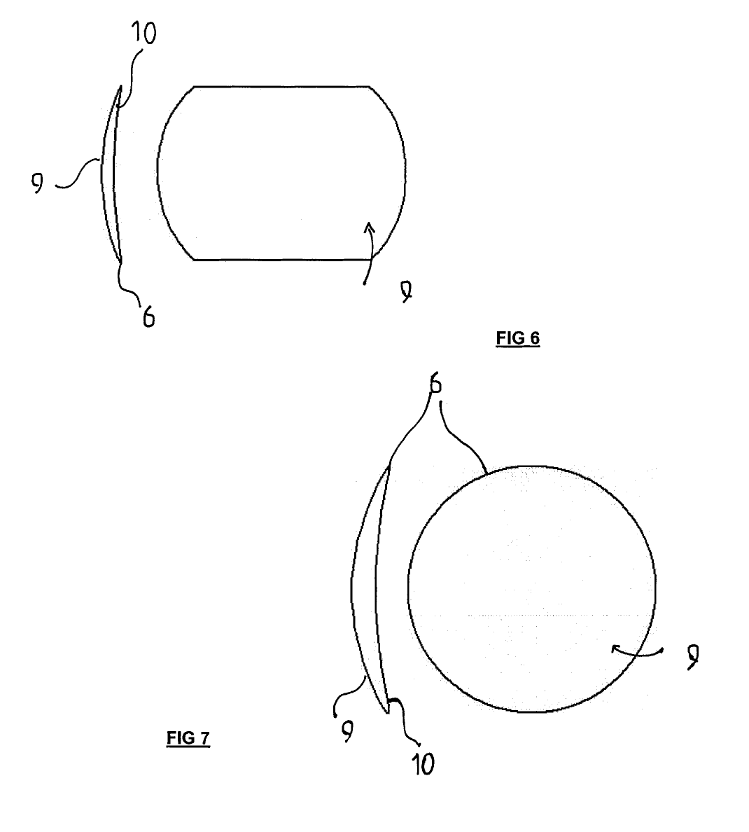

FIGS. 6 and 7 show two possibilities for the external shape of the manufactured lens.

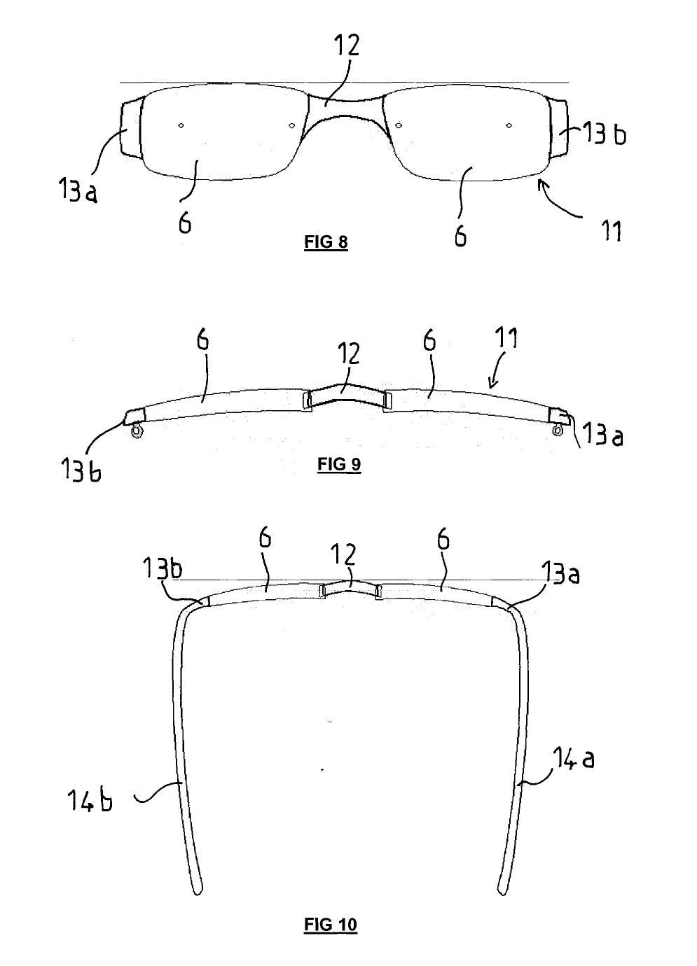

FIGS. 8 and 9 show the front of a pair of glasses including two complex-surface lenses and the sections of the bridge and temples. The glasses are of monoblock construction.

FIG. 10 illustrates a variation with a pair of glasses in which the front (including the lenses) and temples form a single assembly.

The process described here includes the injection of a thermoset polymer into a die 1. This stage is known in its own right and is used with injection materials already available on the market. The injection can be done with any thermoset polymers such as polycarbonate. A material such as methyl polymethacrylate (PMMA) can also advantageously be used. It has very high optical qualities, in particular a high Abbe value.

It has also been noted, surprisingly, that this choice of material was highly advantageous for the manufacture of complex surfaces by injection.

For the purposes of the present description, the term “complex surface” 7 refers to the surface of a lens 6 of the multifocal, progressive multifocal or degressive multifocal type.

Complex surfaces of the degressive multifocal type are used, unusually thanks to the present invention, for the manufacture of close-up glasses providing strong optical correction towards the bottom of the lens and a lighter correction towards the top of the lens. Such close-up glasses, which are currently very expensive because they are individually tooled, give excellent close-up and middle-distance vision (up to approximately 5 metres).

Prior to injection, the manufacturing process involves the production of a specific die 1.

It is possible to use a die in two sections 2, 3 made of steel, preferably with a Rockwell hardness rating of HRC 55, good surface resistance, but still suitable for tooling as described below.

Each of the sections 2, 3 of die 1 includes an imprint (respectively 4, 5) to shape one of the surfaces (respectively 9, 10) of the lens 6.

At least one of the two imprints 4, 5 has a complex surface able to form a lens with at least one of the sides 9, 10 having a complex surface. Generally, the outer surface 9 is formed is such a way that adequate correction is provided by the complex surface while the inner surface 10 is simpler in form, in particular consisting of a concave spherical shape.

However, the process according to the invention can also be applied to the manufacture of lenses 6 with two sides 9, 10 having a complex surface.

The tooling of imprint 4 with a complex surface is achieved in two successive steps according to the invention.

The first stage requires tooling with micrometric-precision numeric machinery, advantageously with a diamond-turning tool that rotates in a spiral from the exterior towards the centre of the complex surface. A computer program is used to define the displacement points of the diamond tool.

This first micrometric stage is followed by nanometric finishing using an numeric diamond-turner. This technology, referred to as “single point diamond turning”, uses a tool with a diamond tip dimensioned such that the precision of the tooling is nanometric. The displacement of the cutting tool is also of nanometric precision, through a combination of electric motors and piezoelectric activators.

The tool's movement is controlled by a computer program of points obtained by increasing the number of points in the file used at the micrometric tooling stage. More particularly, between each point in the micrometric points file, an additional number of points are created and their coordinates adjusted by a smoothing phase which ensures the accurate positioning of each of the new points without losing the continuity of variation in the curve of the complex surface 7.

Surface 7 is generally obtained by a number of successive runs of the cutting tool at decreasing depths.

Machinery using the “single point diamond turning” technique is unusual in the ophthalmic field.

This end-tooling provides a finish on the complex surface 7 such that polishing in unnecessary. Polishing the steel imprint would modify the initial form and the complex surface 7 would be damaged and unusable for the manufacturing of lenses 6.

The other imprint 5 in section 3 of die 1 can be produced using the same two-stage tooling technique (micrometric and nanometric tooling).

If the corresponding side of lens 6 is not complex, especially if it is spherical is shape, a conventional tooling method can be used for imprint 5.

In particular, micrometric tooling and a diamond-turning numeric machine will be used, with a tool displacement point computer program to define a convex spherical surface 8. The surface is then polished in the conventional manner. This does not pose any particular problem if it is spherical.

The production of a third section with conventional tooling has the advantage of reducing manufacturing costs.

In particular, this can be used to produce a die 1 with an interchangeable section 3 depending on the required optical correction, by modifying the spherical characteristics of imprint 5. In doing so, section 2 remains unchanged, producing complex surface 7. The manufacturing costs are again decreased and the number of combinations of optical corrections formed between sections 2 and 3 of die 1 are further increased.

Note that, by polishing the surface of spherical imprint 5, the surface quality of the inner side 10 of lens 6 is of a level acceptable in the ophthalmic optical field.

On section 3 of die 1, it is possible to make the marks generally used to standardise finished, non-routed multifocal lenses. These marks are used to customise the manufactured lens 6 by indicating the centre and the optical parameters of lens 6.

The spherical radius of section 3 is based on the index of the material selected and account must be taken of the shrinkage inherent to all materials during end-of-cycle cooling. Thus, as indicated above, the modification of imprint 5 in section 3 of die 1 alone is sufficient to adapt die 1 to various injection materials.

After creating the two imprints 4 and 5, sections 2 and 3 of die 1 are inserted into an injection frame to produce a finished ophthalmic lens that has all the required optical and geometric properties without the need for further manufacturing processes.

The use of methyl polymethacrylate is particularly worthwhile because of its optical properties and because, surprisingly, it has been noted that the use of this material produced very high quality finished lenses after one injection process using the aforesaid die.

It is therefore apparent that methyl polymethacrylate has advantageous intrinsic properties making it ideal for the production of complex-surface lenses.

The lenses 6 are of the ophthalmic complex-surface type, finished and non-routed. For example, the lens measures 50 mm×70 mm and is equivalent to the shape illustrated in FIG. 6. This type of precalibrated lens has the advantage of being thinner, at equal strength, than lenses with the shape illustrated in FIG. 7.

Another embodiment of the invention is a pair of glasses equipped with invention lenses, made in a single block.

In this case, the die is more complex than above, enabling the monoblock injection of the front surface 11 of the pair of glasses or the front surface 11 and the temples.

More precisely, the portions of the dies corresponding to the lenses are manufactured using the invention process. The remainder of the mould is configured to produce the bridge 12 between the lenses 6 and the earpieces 13a and 13b of the pair of glasses and, where appropriate, the temples 14a and 14b.

The injection is of the bi-injection type, either using different materials for the lenses 6 and the remainder of the glasses or using the same material throughout e.g. PMMA as mentioned above. A single cycle in an injection press is required.

### REFERENCES

1. Die

2. First section

3. Second section

4. First imprint

5. Second imprint

6. Lens

7. Complex surface

8. Convex spherical surface

9. Outer side

10. Inner side

11. Front

12. Bridge

13a, 13b. Earpiece

14a, 14b. Temples

1. Manufacturing process for a lens (6) on which at least one of the sides (9, 10) has a complex surface (7) of the multifocal or progressive multifocal or degressive multifocal type characterised in that it includes the following steps:
1°—production of a die (1) in two sections (2, 3), each including an imprint (4, 5);
2°—tooling of at least one of the imprints (4, 5) by:
initial tooling with a micrometric numeric machine and a tool displacement points computer program to mark out a complex surface (7),
nanometric end tooling using a numeric diamond turning machine;
3°—injection of a thermoset polymer material into the die (1) to manufacture a lens (6) having at least one side (9, 10) with a complex surface (7).

2. Process according to claim 1 in which the two imprints (4, 5) are tooled by step 2 of claim 1.

3. Process according to claim 1 in which the second imprint (5) is tooled by a micrometric numeric machine using a tool displacement points computer program to define a spherical and convex surface (8) before polishing.

4. Process according to claim 1 in which a diamond-turner is used for micrometric precision tooling.

5. Process according to claim 1 in which a polycarbonate-based injection material is used.

6. Process according to claim 1 in which a methyl polymethacrylate injection material is used.

7. Process according to claim 1 in which a steel die (1) with Rockwell hardness rating HRC 55 is used.

8. Process according to claim 1 in which:
die (1) is produced so that it can simultaneously manufacture two lenses with at least one of the sides have a complex surface, and at least the front (11) of a pair of glasses,
injection is realised by a bi-injection process with one or two thermoset polymer materials.

9. Process according to claim 8 in which the die is configured to manufacture the temples of a pair of glasses in a single block with the front (11).

10. Lens (6) obtained by the process according to claim 1.

11. Lens (6) made of polymer plastic for glasses in which at least one of the sides (9, 10) has a complex surface (7) of the multifocal or progressive multifocal or degressive multifocal type characterised in that it consists wholly of injected methyl polymethacrylate.

12. Pair of glasses obtained by the process according to claim 8.

13. Process according to claim 2 in which a diamond-turner is used for micrometric precision tooling.

14. Process according to claim 2 in which a polycarbonate-based injection material is used.

15. Process according to claim 2 in which a methyl polymethacrylate injection material is used.

16. Process according to claim 2 in which a steel die (1) with Rockwell hardness rating HRC 55 is used.

17. Process according to claim 2 in which:
die (1) is produced so that it can simultaneously manufacture two lenses with at least one of the sides have a complex surface, and at least the front (11) of a pair of glasses,
injection is realised by a bi-injection process with one or two thermoset polymer materials.

18. Pair of glasses obtained by the process according to claim 9.
